(19) United States
(12) Patent Application Publication
(10) Pub. No.: US 2012/0174488 A1
(43) Pub. Date: Jul. 12, 2012

(54) Linking-Up Ventilation Door/Window Panel Structure

(75) Inventors: Kun-Zhi Huang, Daliao Township (TW); Qiu-Hui Huang, Daliao Township (TW)

(73) Assignee: CHEN CHANG TECHNOLOGY CO., LTD., Daliao Township (TW)

(21) Appl. No.: 13/005,534

(22) Filed: Jan. 12, 2011

(51) Int. Cl. E06B 3/44

(52) U.S. Cl. 49/408

(57) ABSTRACT

A linking-up ventilation door/window panel structure is described. The linking-up ventilation door/window panel structure includes a window panel, at least one gear set, and a upper ventilation panel and a lower ventilation panel sliding on the window panel, wherein the at least one gear set has at least a first gear rack and second gear rack. A first gear and a second gear are positioned between the first gear rack and the second gear rack and the two gears are pivotally connected to the window panels or the upper ventilation panel and the lower ventilation panel. The linking-up ventilation door/window panel structure links up the other ventilation panel for ventilating air when the user shifts one of the upper ventilation panel and the lower ventilation panel. The linking-up ventilation door/window panel structure having two gears facilitates the operation stability and reduces the noise formed by the linking-up ventilation door/window panel.

### FIELD OF THE INVENTION

The present invention relates to a linking-up ventilation door/window panel structure, and more particularly to a linking-up ventilation door/window panel structure having two gears for facilitating operation stability and reducing the noise formed by the linking-up ventilation door/window panel structure.

### BACKGROUND OF THE INVENTION

Within the indoor space of the building, ventilation window is positioned in the door or the window besides the wall has windows for ventilation. As shown in FIGS. 1 and 2, Taiwan Issued Patent Number 282,815 discloses a conventional linking-up ventilation panel structure, characterized in that a upper air door 102 and a lower air door 103 are positioned in the frame 101 of the door body 100. The upper air door 102 and the lower air door 103 can be adjusted along the frame 101 by the user for upward and downward movement. The gear racks 104 are positioned in the bottom sides of the upper air door 102 and the gear racks 105 are positioned in the top sides of the lower air door 103. The gear rack 104 is embedded to the gear body 106 and the two gear 106 bodies are connected by the rotation rod 107. When the user pushes the one of the air doors, the gear racks 104, 105 move at a relative vertical displacement if the gear racks 104, 105 drive the gear body 106. Thus, another air door can move at a reverse direction so that the upper air door 102 and the lower air door 103 form the ventilation opening in the door body 100. However, the conventional linking-up ventilation panel structure only utilizes a gear body 106 for driving the panel structure. In this case, the gear body 106 has a large loading and generates a loud noise. Further, when the upper ventilation panel and the lower ventilation panel is installed with thicker (greater than 5 mm) glass therein, the loading of the glass exerts on the gear body 106 so that the gear body 106 are driven under extra loading, which result in the damage of the gear body 106. Moreover, the rotation rod 107 is positioned between the upper air door 102 and the lower air door 103, which disadvantageously increases the parallel distance between the upper air door 102 and the lower air door 103, the thickness between the frame 101 and the door body 100 and the cost of the air door.

### SUMMARY OF THE INVENTION

The first objective of the present invention provides a linking-up ventilation door/window panel structure. The linking-up ventilation door/window panel structure includes a window panel, at least one gear set, and a upper ventilation panel and a lower ventilation panel sliding on the window panel. The gear set is positioned between the upper ventilation panel and a lower ventilation panel. Each of the gear sets has a first gear rack and a second gear rack and two gears are positioned between the first gear rack and the second gear rack. The linking-up ventilation door/window panel structure having two gears facilitates the operation stability and reduces the noise formed by the linking-up ventilation door/window panel structure.

The second objective of the present invention provides a linking-up ventilation door/window panel structure. The arrangement of the two gears of the linking-up ventilation door/window panel structure can share the loading of the gear set so that loading of the gear set balances to protect the linking-up ventilation door/window panel structure even though the upper ventilation panel and the lower ventilation panel is installed with thicker glass therein.

According to the above objectives, the present invention sets forth a linking-up ventilation door/window panel structure. The linking-up ventilation door/window panel structure includes a window panel, at least one gear set, and a upper ventilation panel and a lower ventilation panel sliding on the window panel, wherein the at least one gear set has at least a first gear rack and a second gear rack. Two gears are positioned between the first gear rack and the second gear rack and the two gears are pivotally connected to the window panels or the upper ventilation panel and the lower ventilation panel. The linking-up ventilation door/window panel structure links up the other ventilation panel for ventilating the air when the user shifts one of the upper ventilation panel and the lower ventilation panel. Further, the linking-up ventilation door/window panel structure having two gears facilitates the operation stability and reduces the noise formed by the linking-up ventilation door/window panel structure.

In one embodiment, the first gear is engaged with the second gear.

In one embodiment, an intermediate gear set is engaged between the first gear and the second gear.

In one embodiment, the intermediate gear set further comprises a third gear and a fourth gear engaged with the third gear wherein the third gear coaxially rotates with the first gear and the fourth gear coaxially rotates with the second gear.

In one embodiment, the first gear rack and the second gear rack are positioned in lateral sides respectively of the upper ventilation panel and the lower ventilation panel, the first and second gears are engaged between the first gear rack and the second gear rack, and the first and second gears are pivotally connected to the window panel for facilitating the operation stability and reducing the noise of the linking-up ventilation door/window panel structure when the upper ventilation panel and the lower ventilation panel slide on the window panel.

In one embodiment, the first gear rack is positioned in the lower portion of the lateral sides of the upper ventilation panel and the second gear rack is positioned in the upper portion of the lateral sides of the lower ventilation panel.

In one embodiment, the window panel further comprises another gear set and the two gear sets are correspondingly positioned in left and right sides of the window panel for increasing the operation balance of the linking-up ventilation door/window panel structure when the upper ventilation panel and the lower ventilation panel slide on the window panel.

In one embodiment, the height of the first gear rack is greater than the height of the second gear rack.

In one embodiment, the width of the first gear is greater than the width of the second gear.

In one embodiment, the first gear rack is engaged with the first gear and the second gear rack is engaged with the second gear to allow the upper ventilation panel and the lower ventilation panel to be open and close along conversely up and down directions on the window panel when one of the upper ventilation panel and the lower ventilation panel is shifted by synchronously rotating the first gear and the second gear.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic conventional three-dimensional view of ventilation door panel structure;

FIG. 2 is a schematic conventional three-dimensional view of ventilation door panel structure;

FIGS. 3A-3B are schematic lateral cross-sectional views of linking-up ventilation door/window panel structure according to a first embodiment of the present invention;

FIGS. 4A-4B are schematic front cross-sectional views of linking-up ventilation door/window panel structure according to a second embodiment of the present invention;

FIG. 5A is schematic partial exploded three-dimensional view of linking-up ventilation door/window panel structure according to the second embodiment of the present invention;

FIG. 5B is schematic partial lateral view of linking-up ventilation door/window panel structure according to the second embodiment of the present invention;

FIG. 5C is schematic partial top view of linking-up ventilation door/window panel structure according to the second embodiment of the present invention;

FIG. 6 is schematic partial front cross-sectional view of linking-up ventilation door/window panel structure according to a third embodiment of the present invention; and

FIG. 7 is schematic partial top view of linking-up ventilation door/window panel structure according to the third embodiment of the present invention.

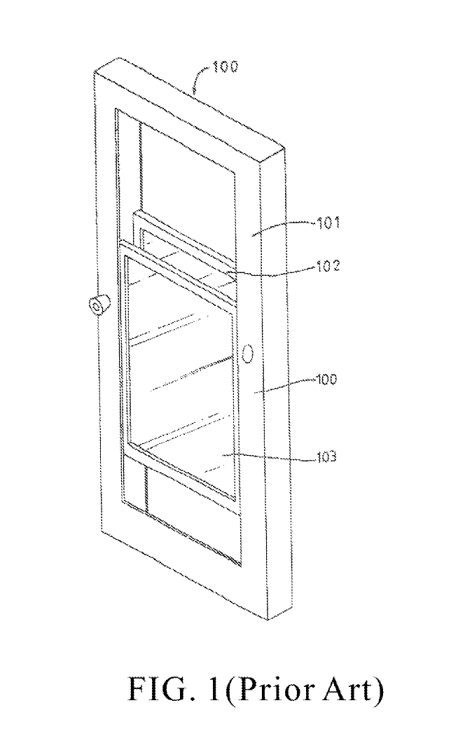

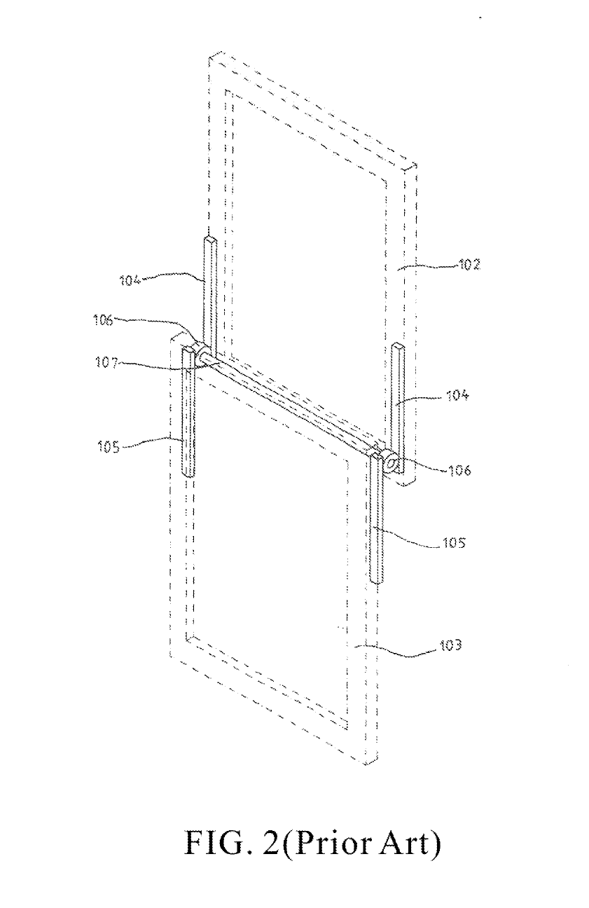

### DETAILED DESCRIPTION OF THE PREFERRED EMBODIMENTS

The linking-up ventilation door/window panel structure in the present invention is applied to the various kinds of ventilation panel structure, which allows the upper ventilation panel and the lower ventilation panel to be open and close along up and down directions on the window panel.

Further, because a conventional linking-up ventilation panel structure which functions as a linking-up type has a gear body arranged in the lateral side for a driving operation, the gear body has a large loading, which results in a loud noise. Particularly, the gear body is damaged early due to the large loading for a long time if the linking-up ventilation door/window panel structure is installed with thicker glass therein.

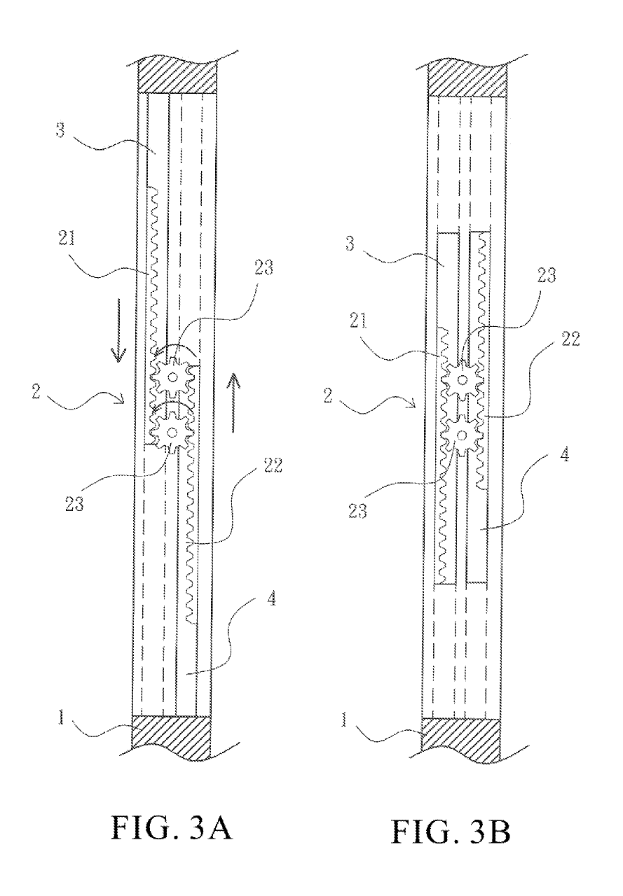

FIGS. 3A-3B are schematic lateral cross-sectional views of linking-up ventilation door/window panel structure according to a first embodiment of the present invention. The linking-up ventilation door/window panel structure includes a window panel 1, at least one gear set 2, and a upper ventilation panel 3 and a lower ventilation panel 4 sliding on the window panel therein 1. The at least one gear set 2 has at least a first gear rack 21 and a second gear rack 22, The linking-up ventilation door/window panel structure is characterized in that two gears 23 are positioned between the first gear rack 21 and the second gear rack 22 of the gear set 2.

As shown in FIGS. 3A-3B, the first gear rack 21 and the second gear rack 22 are positioned in lateral sides respectively of the upper ventilation panel 3 and the lower ventilation panel 4, the two gears 23 are engaged between the first gear rack 21 and the second gear rack 22, and the two gears 23 are pivotally connected to the window panel 1 and/or positioned on the upper ventilation panel 3 and the lower ventilation panel 4. Therefore, when user shifts one of the upper ventilation panel 3 and the lower ventilation panel 4, the other of the upper ventilation panel 3 and the lower ventilation panel 4 is shifted synchronously. That is, the upper ventilation panel 3 and the lower ventilation panel 4 are driven synchronously. As shown in FIG. 3A, when the upper ventilation panel 3 moves downward on the window panel 1, the first gear rack 21 accompanied with the upper ventilation panel 3 moves downward. Reversely, when the lower ventilation panel 4 is shifted upward, the upper ventilation panel 3 moves downward. The operation stability of the upper ventilation panel 3 and the lower ventilation panel 4 is improved by using the two gears 23 and the noise formed by the linking-up ventilation door/window panel structure is decreased when the upper ventilation panel 3 and the lower ventilation panel 4 slide on the window panel 1. Moreover, the arrangement of the two gears 23 can share the loading of the gear set 2 so that loading of the gear set 2 balances to protect the linking-up ventilation door/window panel structure even though the upper ventilation panel 3 and the lower ventilation panel 4 is installed with thicker glass therein.

Please refer to FIG. 3B again. Because the displacement of the upper ventilation panel 3 and the lower ventilation panel 4 on the window panel 1 is half height of the window panel 1, the upper ventilation panel 3 and the lower ventilation panel 4 can easily be driven to the middle position of the window panel 1. The first gear rack 21 is positioned in the lower portion of the upper ventilation panel 3 and the second gear rack 22 is positioned in the upper portion of the lower ventilation panel 4.

Besides, the first gear rack 21 and the second gear rack 22 are positioned in lateral sides respectively of the upper ventilation panel 3 and the lower ventilation panel 4, the window panel 1 further includes another gear set 2 and the two gear sets 2 are correspondingly positioned in left and right sides of the window panel 1 for increasing the operation balance of the linking-up ventilation door/window panel structure when the upper ventilation panel 3 and the lower ventilation panel slide 4 on the window panel 1.

In addition, the gear set 2 is selected from one group consisting of a spur gear, a bevel gear and a double-helical gear to improve the driving efficiency and decreasing the loud noise of the gear set 2.

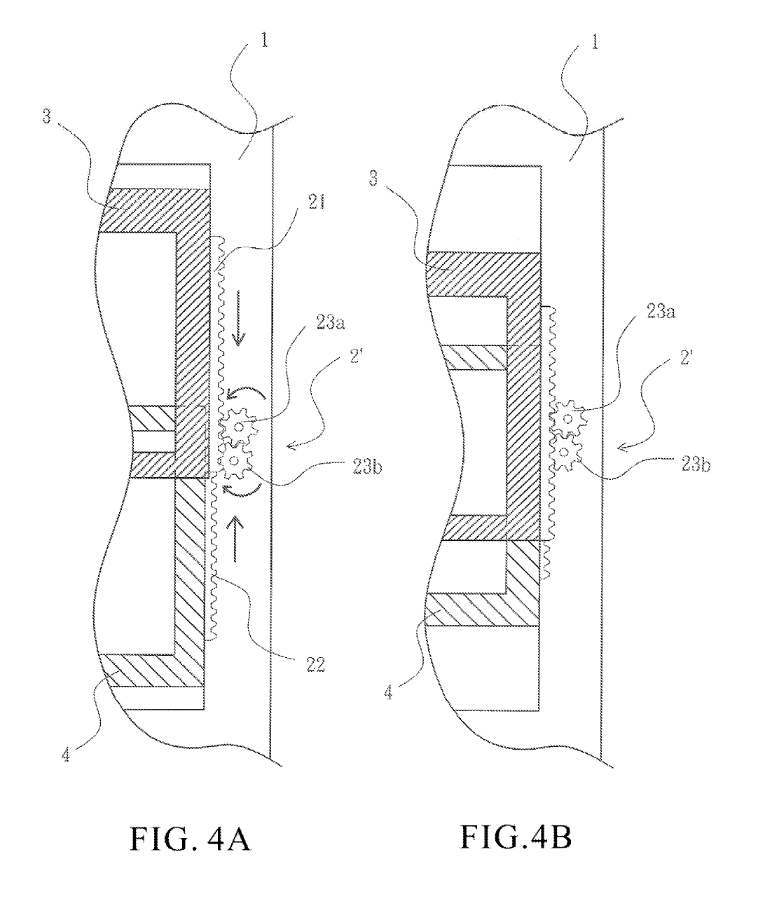

FIGS. 4A-4B are schematic front cross-sectional views of linking-up ventilation door/window panel structure according to a second embodiment of the present invention. The linking-up ventilation door/window panel structure includes a window panel 1, at least one gear set 2′, and a upper ventilation panel 3 and a lower ventilation panel 4 sliding on the window panel 1 therein, wherein the at least one gear set 2′ has at least a first gear rack 21 and a second gear rack 22. The linking-up ventilation door/window panel structure is characterized in that the first gear rack 21 and the second gear rack 22 are positioned in lateral sides respectively of the upper ventilation panel 3 and the lower ventilation panel 4, and the two gears having a first gear 23a and a second gear 23b are pivotally connected to the window panel 1, wherein the first gear rack 21 and the second gear rack 22 are engaged with the first gear 23a and the second gear 23b of the two gears, and the first gear 23a is engaged with the second gear 23b. The second embodiment is similar to the first embodiment but the difference is that rotation plane of the first gear 23a and the second gear 23b of the gear set 2′ is parallel to the panel plane of the upper ventilation panel 3 and the lower ventilation panel 4. Further, the gear type of the first gear rack 21 and the second gear rack 22 are arranged outward.

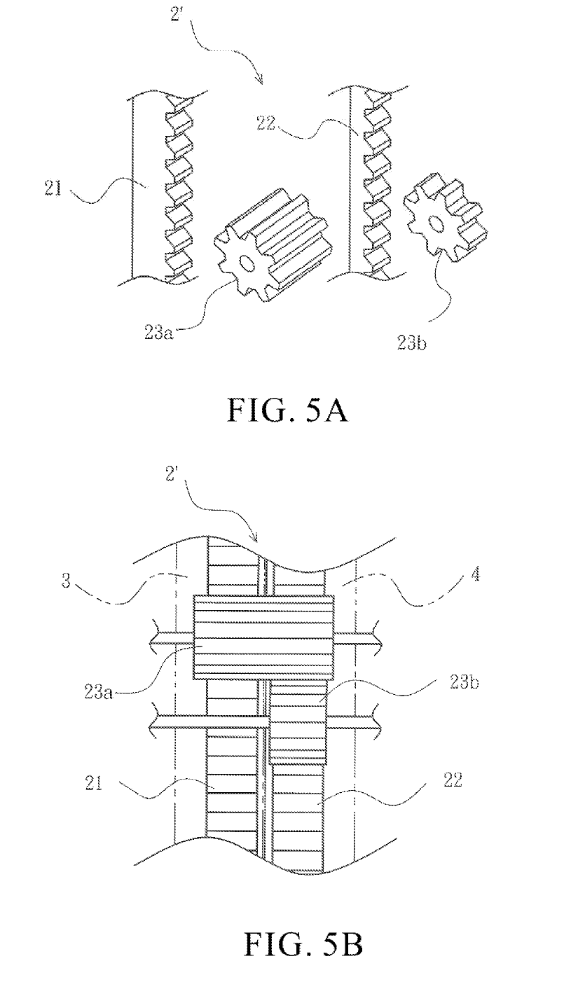

Please refer to FIGS. 5A-5C. These figures show schematic partial views of linking-up ventilation door/window panel structure. FIG. 5A is schematic partial exploded three-dimensional view of linking-up ventilation door/window panel structure according to the second embodiment of the present invention. FIG. 5B is schematic partial lateral view of linking-up ventilation door/window panel structure according to the second embodiment of the present invention. FIG. 5C is schematic partial top view of linking-up ventilation door/window panel structure according to the second embodiment of the present invention.

The height of the first gear rack 21 is greater than the height of the second gear rack 22. The width of the first gear 23a is greater than the width of the second gear 23b. The first gear 23a is engaged with the second gear 23b and the first gear 23a and the second gear 23b are engaged with the first gear rack 21 and the second gear rack 22, respectively. Therefore, the first gear rack 21 and the first gear 23a are engaged and driven synchronously, the first gear 23a and the second gear 23b are engaged and driven synchronously, and the second gear 23b and the second gear rack 22 are engaged and driven synchronously.

Please refer to FIGS. 4A and 4B again. When one of the upper ventilation panel 3 and the lower ventilation panel 4 is shifted, the other of the upper ventilation panel 3 and the lower ventilation panel 4 is synchronously driven. As shown in FIG. 4A, when the upper ventilation panel 3 moves downward on the window panel 1, the first gear rack 21 accompanied with the upper ventilation panel 3 moves downward for driving the first gear 23a to be rotated in a counterclockwise mode. Further, because the first gear 23a is engaged with the second gear 23b, the second gear 23b is driven in a clockwise mode and thus the second gear rack 22 and the lower ventilation panel 4 synchronously move upward. On the contrary, when the lower ventilation panel 4 moves upward on the window panel 1, the upper ventilation panel 3 is driven to move downward.

In the second embodiment of the present invention, the linking-up ventilation door/window panel structure utilizes the height difference between the first gear rack 21 and the second gear rack 22 and the width difference between the first gear 23a and the second gear 23b for driving the gear set 2′. The driving sequence of the gear set 2′ is that the first gear rack 21, the first gear 23a, the second gear 23b and the second gear rack 22, but not limited.

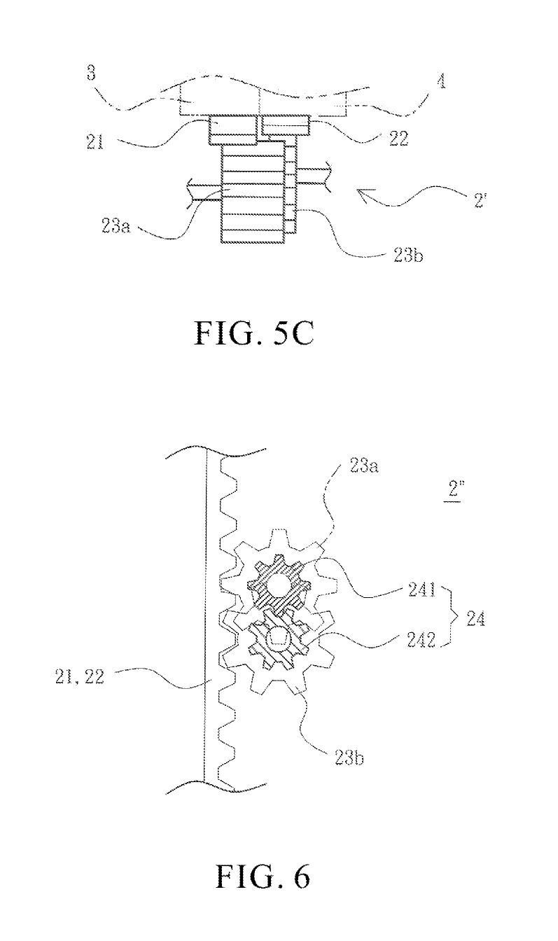

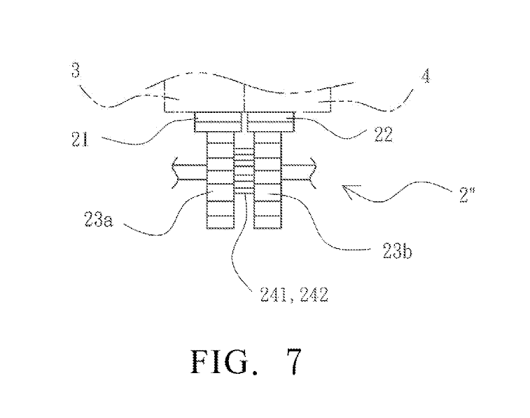

Please refer to FIGS. 6 and 7. FIG. 6 is schematic partial front cross-sectional view of linking-up ventilation door/window panel structure according to a third embodiment of the present invention. FIG. 7 is schematic partial top view of linking-up ventilation door/window panel structure according to the third embodiment of the present invention. The third embodiment is similar to the second embodiment but the difference is that the gear set 2″ has a first gear rack 21 and the second gear rack 22 wherein the heights of the first gear rack 21 and the second gear rack 22 are the same. The first gear 23a and a second gear 23b are engaged between the first gear rack 21 and the second gear rack 22 and an intermediate gear set 24 is engaged between the first gear 23a and the second gear 23b. The intermediate gear set 24 further includes a third gear 241 and a fourth gear 242 engaged with the third gear 241 wherein the third gear 241 coaxially rotates with the first gear 23a and the fourth gear 242 coaxially rotates with the second gear 23b.

As shown in FIGS. 6 and 7, the first gear 23a is engaged with the first gear rack 21 and the second gear 23b is engaged with the second gear rack 22. The driving sequence of the gear set 2′ is that the first gear rack 21, the first gear 23a, the second gear 23b and the second gear rack 22. The first gear rack 21 is engaged with the first gear 23a and the second gear rack 22 is engaged with the second gear 23b to allow the upper ventilation panel 3 and the lower ventilation panel 4 to be open and close along conversely up and down directions on the window panel 1 when one of the upper ventilation panel 3 and the lower ventilation panel 4 is shifted by synchronously rotating the intermediate gear set 24.

In comparison to conventional linking-up ventilation panel structure, the gear body of the linking-up ventilation panel structure has a large loading, which results in a loud noise. Particularly, the gear body is damaged early due to the large loading for a long time. The present invention provides a linking-up ventilation door/window panel structure for linking up the other ventilation panel and ventilating the air when the user shifts one of the upper ventilation panel and the lower ventilation panel. The linking-up ventilation door/window panel structure having two gears facilitates the operation stability and reduces the noise formed by the linking-up ventilation door/window panel structure to improve the load ability of the gear set.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A linking-up ventilation door/window panel structure, comprising a window panel, at least one gear set, and a upper ventilation panel and a lower ventilation panel sliding on the window panel therein, wherein the at least one gear set has at least a first gear rack and a second gear rack, characterized in that a first gear and a second gear are positioned between the first gear rack and the second gear rack.

2. The linking-up ventilation door/window panel structure of claim 1, characterized in that the first gear is engaged with the second gear.

3. The linking-up ventilation door/window panel structure of claim 1, characterized in that an intermediate gear set is engaged between the first gear and the second gear.

4. The linking-up ventilation door/window panel structure of claim 3, characterized in that the intermediate gear set further comprises a third gear and a fourth gear engaged with the third gear wherein the third gear coaxially rotates with the first gear and the fourth gear coaxially rotates with the second gear.

5. The linking-up ventilation door/window panel structure of claim 1, characterized in that the first gear rack is engaged with the first gear and the second gear rack is engaged with the second gear to allow the upper ventilation panel and the lower ventilation panel to be open and close along conversely up and down directions on the window panel when one of the upper ventilation panel and the lower ventilation panel is shifted by synchronously rotating the first gear and the second gear.

6. The linking-up ventilation door/window panel structure of claim 1, characterized in that the first gear rack and the second gear rack are positioned in lateral sides respectively of the upper ventilation panel and the lower ventilation panel, the first and second gears are engaged between the first gear rack and the second gear rack, and the first and second gears are pivotally connected to the window panel for facilitating the operation stability and reducing the noise of the linking-up ventilation door/window panel structure when the upper ventilation panel and the lower ventilation panel slide on the window panel.

7. The linking-up ventilation door/window panel structure of claim 6, characterized in that the first gear rack is positioned in the lower portion of the lateral sides of the upper ventilation panel and the second gear rack is positioned in the upper portion of the lateral sides of the lower ventilation panel.

8. The linking-up ventilation door/window panel structure of claim 1, characterized in that the window panel further comprises another gear set and the two gear sets are correspondingly positioned in left and right sides of the window panel for increasing the operation balance of the linking-up ventilation door/window panel structure when the upper ventilation panel and the lower ventilation panel slide on the window panel.

9. The linking-up ventilation door/window panel structure of claim 1, characterized in that the height of the first gear rack is greater than the height of the second gear rack.

10. The linking-up ventilation door/window panel structure of claim 1, characterized in that the width of the first gear is greater than the width of the second gear.

11. The linking-up ventilation door/window panel structure of claim 1, characterized in that the first gear rack is engaged with the first gear and the second gear rack is engaged with the second gear to allow the upper ventilation panel and the lower ventilation panel to be open and close along conversely up and down directions on the window panel when one of the upper ventilation panel and the lower ventilation panel is shifted by synchronously rotating the first gear and the second gear.
